(19) United States
(12) Patent Application Publication
(10) Pub. No.: US 2021/0048286 A1
(43) Pub. Date: Feb. 18, 2021

(54) DETECTION DEVICE

(71) Applicant: AZBIL CORPORATION, Chiyoda-ku (JP)

(72) Inventors: Toshiki KOSHI, Chiyoda-ku (JP); Nagayuki SATOU, Chiyoda-ku (JP); Ryoichi TAJIMA, Chiyoda-ku (JP)

(73) Assignee: AZBIL CORPORATION, Chiyoda-ku (JP)

(21) Appl. No.: 16/979,693

(22) PCT Filed: Mar. 6, 2019
(86) PCT No.: PCT/JP2019/008902

§ 371 Date: Sep. 10, 2020

(30) Foreign Application Priority Data
Mar. 19, 2018 (JP) 2018-050892

(51) Int. Cl. G01B 11/02; G01S 17/10

(52) U.S. Cl. CPC G01B 11/026; G01S 17/10

(57) ABSTRACT

A detection device includes a light projection unit that projects light to a detection region, a lens that focuses the light having been projected from the light projection unit and reflected by the detection region, an image sensor that includes a plurality of light receiving elements and receives the light focused by the lens for each of the light receiving elements, a distance calculation unit that calculates, on the basis of a result of light reception by the image sensor, a distance to an object present in the detection region with a TOF method for each of light reception positions at which the light receiving elements are located, and a position calculation unit that calculates a position of the object present in the detection region on the basis of the distance calculated by the distance calculation unit for each light reception position.

### TECHNICAL FIELD

The present invention relates to a detection device for detecting a position of an object present in a detection region.

### BACKGROUND ART

Hitherto, an edge sensor is known as a detection device for detecting a position of an object (target to be detected) present in a detection region (see, for example, Patent Literature (PTL) 1). The known edge sensor is a transmission-type sensor including a light projection unit and a light receiving unit that are placed opposite to each other, and is able to detect an edge position of the object by detecting a position of the boundary between light and shadow from a result of light reception by the light receiving unit.

### CITATION LIST

### Patent Literature [0003]

PTL 1: Japanese Unexamined Patent Application Publication No. 2004-226372

### SUMMARY OF INVENTION

### Technical Problem

However, because of being the transmission type, the related-art edge sensor needs to install sensor units (namely, the light projection unit and the light receiving unit) on both sides of the detection region. Furthermore, because of being the transmission type, the related-art edge sensor has a difficulty in aligning optical axes between the light projection unit and the light receiving unit. In addition, a detection range of the related-art edge sensor is narrow. Moreover, in the related-art edge sensor, an optical system is expensive because of the necessity of using, for example, a laser beam or a telecentric lens with high parallelism.

When the telecentric lens is used in the related-art edge sensor, the edge position of the object can be calculated from a formula (1) given below. In the formula (1), x₁ denotes the edge position of the object, x₂ denotes an edge position of an image of the object in the light receiving unit, and N denotes a magnification of the telecentric lens.

x₁=N×x₂ (1)

The present invention has been made to solve the above-described problem, and an object of the present invention is to provide a detection device that is a reflection-type device and that is able to detect an object position.

### Solution to Problem

A detection device according to the present invention includes a light projection unit that projects light to a detection region, a lens that focuses the light having been projected from the light projection unit and reflected by the detection region, an image sensor that includes a plurality of light receiving elements and receives the light focused by the lens for each of the light receiving elements, a distance calculation unit that calculates, on the basis of a result of light reception by the image sensor, a distance to an object present in the detection region with a TOF method for each of light reception positions at which the light receiving elements are located, and a position calculation unit that calculates a position of the object present in the detection region on the basis of the distance calculated by the distance calculation unit for each light reception position.

### Advantageous Effects of Invention

Because of having the above-described feature, the detection device according to the present invention is a reflection-type device and is able to detect the object position.

### BRIEF DESCRIPTION OF DRAWINGS

FIG. 1 is a block diagram illustrating an example of configuration of a detection device according to Embodiment 1 of the present invention.

FIGS. 2A and 2B illustrate an example of configuration of a sensor head in Embodiment 1 of the present invention; specifically, FIG. 2A illustrates an example of an internal structure of the sensor head, and FIG. 2B illustrates an example of an external appearance of the sensor head.

FIG. 3 is a flowchart illustrating an example of operation of the detection device according to Embodiment 1 of the present invention.

FIG. 4 is a timing chart illustrating examples of operations of a light projection unit and a light receiving unit in Embodiment 1 of the present invention.

FIGS. 5A and 5B are charts referenced to explain examples of operations of a distance calculation unit and a position calculation unit in Embodiment 1 of the present invention; specifically, FIG. 5A illustrates an example of relation between a light reception position and a light reception time, and FIG. 5B illustrates an example of relation between the light reception position and a distance.

FIGS. 6A and 6B are charts referenced to explain examples of operations of the distance calculation unit and the position calculation unit in Embodiment 1 of the present invention; specifically, FIG. 6A illustrates an example of relation between the light reception position and the light reception time, and FIG. 6B illustrates an example of relation between the light reception position and the distance.

FIG. 7 illustrates a specific example of operation of the detection device according to Embodiment 1 of the present invention.

FIG. 8 is a table representing examples of a result of light reception by the light receiving unit and a result of calculation by the distance calculation unit in Embodiment 1 of the present invention.

FIGS. 9A and 9B are explanatory views referenced to explain width calculation by a detection device according to Embodiment 2 of the present invention; specifically, FIG. 9A illustrates an example of positional relation between an object and the light receiving unit, and FIG. 9B illustrates an example of relation between the light reception position and the distance.

### DESCRIPTION OF EMBODIMENTS

Embodiments of the present invention will be described in detail below with reference to the drawings.

### Embodiment 1

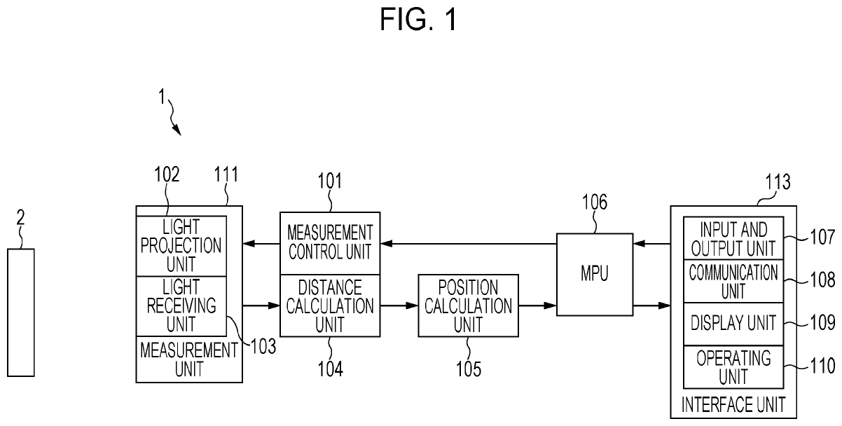

The detection device 1 measures a position of an object (target to be detected) 2 present in a detection region and a width of the object 2. The detection device 1 is used as a sensor in industrial (technological industrial) fields. In Embodiment 1, a detection target surface of the object 2 is assumed to be parallel (including the meaning of “substantially parallel”) with respect to a light receiving surface of an image sensor 1033 described later. As illustrated in FIG. 1, the detection device 1 includes a measurement control unit 101, a light projection unit 102, a light receiving unit 103, a distance calculation unit 104, a position calculation unit 105, a MPU (Micro Processing Unit) 106, an input and output unit 107, a communication unit 108, a display unit 109, and an operating unit 110. Moreover, the detection device 1 is constituted as a reflection-type device in which the light projection unit 102 and the light receiving unit 103 are both placed opposite to the detection region.

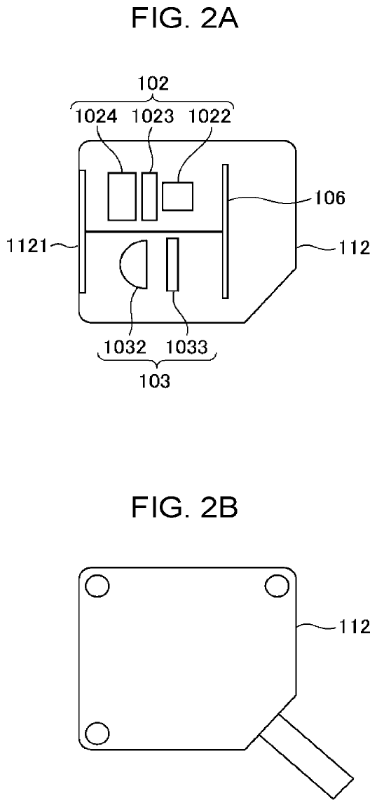

The light projection unit 102 and the light receiving unit 103 constitute a measurement unit 111. Referring to FIG. 2, the measurement control unit 101, the light projection unit 102, the light receiving unit 103, the distance calculation unit 104, the position calculation unit 105, and the MPU 106 are mounted to a sensor head 112. A filter 1121 is disposed in front of the sensor head 112 illustrated in FIG. 2. It is to be noted that, in FIG. 2, the measurement control unit 101, the distance calculation unit 104, and the position calculation unit 105 are omitted.

The input and output unit 107, the communication unit 108, the display unit 109, and the operating unit 110 constitute an interface unit 113.

The measurement control unit 101 generates a control signal in accordance with control information input through the MPU 106. The control signal controls timing of light projection by the light projection unit 102 depending on a light receiving operation of the image sensor 1033. The control signal generated by the measurement control unit 101 is output to the light projection unit 102.

The light projection unit 102 projects pulsed light to the detection region in accordance with the control signal from the measurement control unit 101. A beam shape of the light projected from the light projection unit 102 is set in advance. In FIG. 2, the light projection unit 102 is constituted by a light projection board (not illustrated) 1021 that is a circuit board, a light emitting element 1022 that emits light, an aperture 1023 that is a diaphragm placed in front of the light emitting element 1022, and a diffuser 1024 that diffuses the light having been emitted from the light emitting element 1022 and having passed through the aperture 1023. A width of the light projected from the light projection unit 102 and a period of the light projection are determined depending on a distance to the object 2, a moving speed thereof, and so on, which are estimated. The light projection unit 102 may modulate the projected light.

The light receiving unit 103 receives the light having been projected from the light projection unit 102 and reflected by the detection region. In FIG. 2, the light receiving unit 103 is constituted by a light receiving board (not illustrated) 1031 that is a circuit board, a lens 1032, and the image sensor 1033.

The lens 1032 focuses the light having been projected from the light projection unit 102 and reflected by the detection region. The lens 1032 is a non-telecentric lens.

The image sensor 1033 includes a plurality of light receiving elements and receives the light focused by the lens 1032 for each of the light receiving elements. The following description is made on an assumption that the image sensor 1033 is a linear-type sensor including the plurality of light receiving elements arrayed in a one-dimensional direction. The linear-type image sensor 1033 is adaptable for rapid response demanded for an industrial sensor. Information indicating a result of light reception by the image sensor 1033 is output to the distance calculation unit 104.

The image sensor 1033 may output as the information indicating the result of the light reception, for example, information indicating a delay time that represents, with respect to a time when the light has been projected from the light projection unit 102 (namely, a light projection time), a time when the light has been received by each light receiving element (namely, a light reception time). In the case of the light projection unit 102 modulating the light, the image sensor 1033 may output as the information indicating the result of the light reception, for example, information indicating a phase difference between the light projected from the light projection unit 102 and the light received by each light receiving element.

The distance calculation unit 104 calculates, on the basis of the result of the light reception by the image sensor 1033, the distance from the image sensor 1033 to the object 2 present in the detection region with a TOF (Time Of Flight) method for each of light reception positions at which the light receiving elements are located. Information indicating the distance for each light reception position (distance information) calculated by the distance calculation unit 104 is output to the position calculation unit 105 and the MPU 106.

The position calculation unit 105 calculates, on the basis of the distance calculated by the distance calculation unit 104 for each light reception position, a position of an image of the object 2, the image being focused by the image sensor 1033. Information indicating the position of the image of the object 2 (position information) calculated by the position calculation unit 105 is output to the MPU 106. [0019]

The MPU 106 calculates a position of the object 2 on the basis of the distance calculated by the distance calculation unit 104 for each light reception position and the position of the image of the object 2 calculated by the position calculation unit 105. At that time, the MPU 106 calculates the position to the object 2 on the basis of the position of the image of the object 2 focused by the image sensor 1033, the distance from the image sensor 1033 to the object 2, and the focal length of the lens 1032. Information indicating the position of the object 2, the information being calculated by the MPU 106, is output to the interface unit 113.

Furthermore, the MPU 106 calculates a width of the object 2 on the basis of the distance calculated by the distance calculation unit 104 for each light reception position and the position of the image of the object 2 calculated by the position calculation unit 105. At that time, the MPU 106 calculates the width of the object 2 on the basis of a width of the image of the object 2 focused by the image sensor 1033, the distance from the image sensor 1033 to the object 2, and the focal length of the lens 1032. Information indicating the width of the object 2, the information being calculated by the MPU 106, is output to the interface unit 113. The calculation of the width of the object 2 by the MPU 106 is not essential processing, and it may not need to be executed.

The position calculation unit 105 and the MPU 106 constitute an “object position calculation unit that calculates the position of the object 2 on the basis of the distance calculated by the distance calculation unit 104 for each light reception position” and an “object width calculation unit that calculates the width of the object 2 on the basis of the distance calculated by the distance calculation unit 104 for each light reception position”.

The measurement control unit 101, the distance calculation unit 104, and the position calculation unit 105 are realized with, for example, a processing circuit such as a system LSI (Large Scale Integration), or a CPU (Central Processing Unit) that executes a program stored in a memory or the like.

The input and output unit 107 is used to input various settings for the detection device 1 and to generate the control information for outputting to the MPU 106. The control information includes, for example, a trigger signal instructing the light projection by the light projection unit 102, and further includes, when a laser beam is used in the light projection unit 102, a stop signal instructing stop of the laser beam.

In addition, the input and output unit 107 outputs information input from the MPU 106. At that time, the input and output unit 107 may issue, for example, an analog output or an on-output when threshold determination is performed and a threshold is exceeded.

The communication unit 108 performs communication with an external device via a network such as Ethernet (registered trademark), for example, and transmits the information input from the MPU 106, for example, to the external device.

The display unit 109 performs various types of display operations. Furthermore, the display unit 109 displays the information input from the MPU 106. For example, in the case of displaying the position of the object 2, the display unit 109 displays, as a numerical value, how far away the object 2 is positioned from an optical axis of the light receiving unit 103 with a point on the optical axis being zero.

The operating unit 110 accepts a user operation and performs, for example, display switching of the display unit 109, various settings on the detection device 1, and so on.

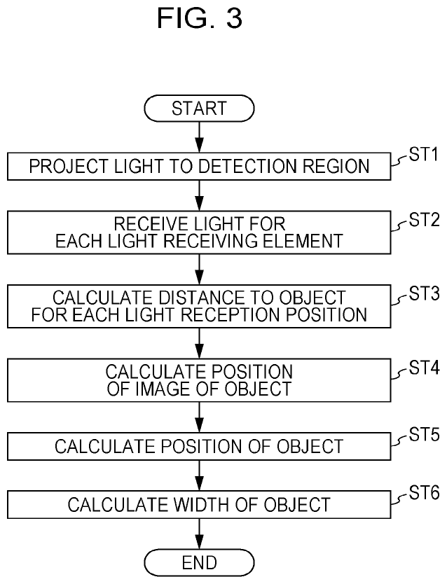

An example of operation of the detection device 1 according to Embodiment 1 will be described below with reference to FIG. 3. The following description is made in connection with the case in which the MPU 106 calculates the position and the width of the object 2.

In accordance with the control signal from the measurement control unit 101, the light projection unit 102 projects the pulsed light to the detection region (step ST1).

The light projected from the light projection unit 102 is reflected by the object 2 present in the detection region and is incident on the image sensor 1033 through the lens 1032. If any background such as a wall is present in the detection region, the light projected from the light projection unit 102 is reflected by the background as well and is also incident on the image sensor 1033 through the lens 1032.

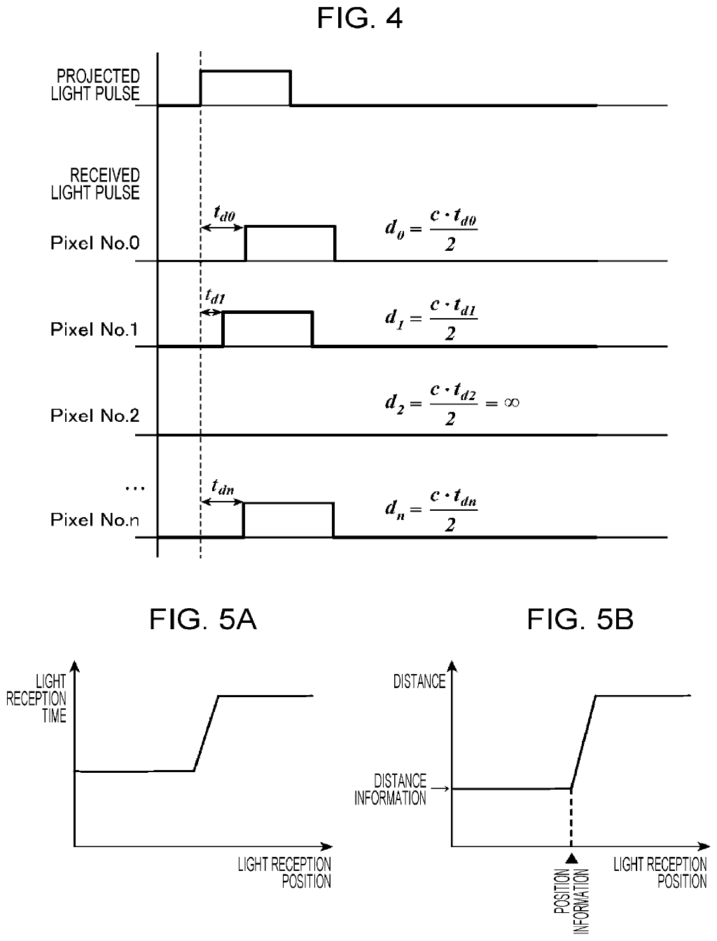

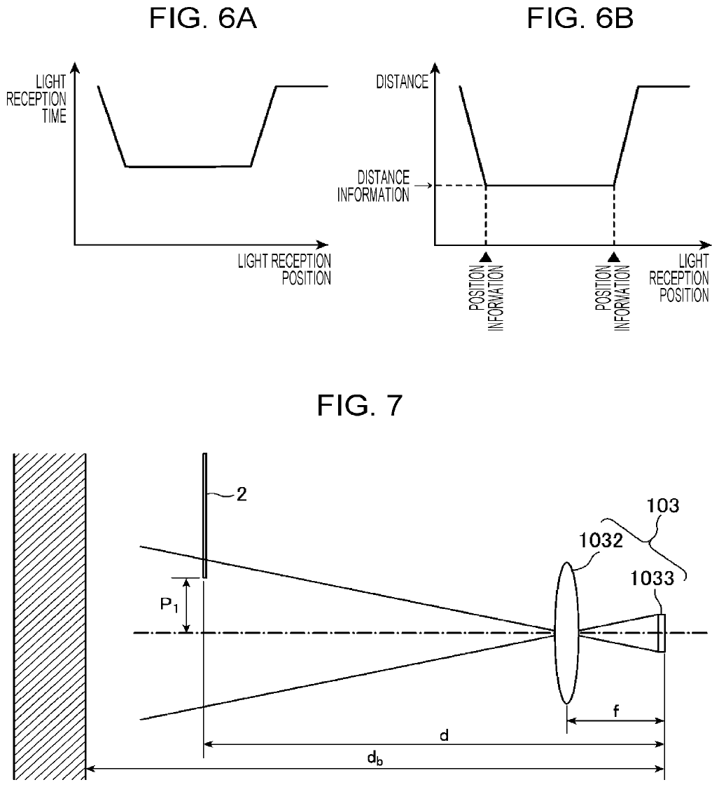

Then, the image sensor 1033 receives the incident light for each light receiving element (step ST2). As illustrated in FIG. 4, timings of receiving the light by the individual light receiving elements (Pixel No. 0 to No. n) of the image sensor 1033 (namely, reception timings of received light pulses) are delayed with respect to a timing of projecting the light by the light projection unit 102 (namely, a projection timing of a projected light pulse) depending on distances between the individual light receiving elements and the object 2. In the following description, it is assumed that the image sensor 1033 outputs, as the above-described information indicating the result of the light reception, information indicating the light reception time (delay time) at each light receiving element. Relations between the light reception position and the light reception time, illustrated by way of example in FIGS. 5A and 6A, are obtained with the image sensor 1033.

Then, the distance calculation unit 104 calculates, on the basis of the result of the light reception by the image sensor 1033, the distance to the object 2 with the TOF (Time Of Flight) method for each of the light reception positions at which the light receiving elements are located (step ST3).

On that occasion, the distance calculation unit 104 first calculates, on the basis of the result of the light reception by the image sensor 1033, a distance to a position at which the light received by the light receiving element has been reflected (namely, to a reflection point) for each light reception position by using a formula (3) given below. In the formula (3), dᵢ denotes the distance to the reflection point for the light received by the i-th light receiving element, c denotes the velocity of light, and t_{di} denotes the reception time at the i-th light receiving element.

dᵢ=c×t_{di}/2 (3)

Here, the distance from the light reception position to the reflection point, obtained from the formula (3), is a distance along a direction inclined by an angle θᵢ with respect to the optical axis of the light receiving unit 103. The angle θᵢ is an angle formed between a segment connecting a position of the optical axis on the lens 1032 and the i-th light receiving element and the optical axis, and it is known. The distance calculation unit 104 converts the calculated distance to the reflection point into a distance measured parallel (including the meaning of “substantially parallel”) to the optical axis of the light receiving unit 103 for each light reception position with the use of the angle θᵢ.

Then, the distance calculation unit 104 obtains the distance to the object 2 from the distance to the reflection point, the latter distance being obtained with the above-described conversion for each light reception position. At this time, the distance calculation unit 104 excludes one of the distances to the reflection points obtained with the above-described conversion, the one representing the distance from the image sensor 1033 to the background. In Embodiment 1, because the detection target surface of the object 2 is parallel to the light receiving surface of the image sensor 1033, the distance to the object 2 is given as the same value for all the light reception positions. Thus the distance information illustrated in each of FIGS. 5B and 6B, for example, is obtained with the distance calculation unit 104.

Then, the position calculation unit 105 calculates, on the basis of the distance information obtained with the distance calculation unit 104, the position of the image of the object 2 focused by the image sensor 1033 (step ST4). For example, FIGS. 5B and 6B represent the position information when the position calculation unit 105 has detected an edge position of the image.

Then, the MPU 106 calculates the position of the object 2 on the basis of both the distance information obtained with the distance calculation unit 104 and the position information obtained with the position calculation unit 105 (step ST5).

On that occasion, the MPU 106 calculates the position of the object 2 by using a formula (4) given below. In the formula (4), x₁ denotes the position of the object 2, and x₂ denotes the position of the image of the object 2 (i.e., the light reception position). Furthermore, d denotes the distance between the object 2 and the image sensor 1033, and f denotes the distance between the lens 1032 and the image sensor 1033 (namely, the focal length). Moreover, {(d−f)/f} in the formula (4) denotes a magnification of an optical system.

xᵢ={(d−f)/f}×x₂ (4)

In addition, the MPU 106 calculates the width of the object 2 on the basis of both the distance information obtained with the distance calculation unit 104 and the position information obtained with the position calculation unit 105 (step ST6).

On that occasion, the MPU 106 calculates the width of the object 2 by using a formula (5) given below. In the formula (5), w₁ denotes the width of the object 2, and w₂ denotes the width of the image of the object 2. Note that, when positions of both ends of an image are not detected by the position calculation unit 105, the MPU 106 does not perform a width calculation process.

w₁={(d−f)/f}×w₂ (5)

Here, the detection device 1 according to Embodiment 1 is constituted as the reflection-type device in which a sensor (including the light projection unit 102 and the light receiving unit 103) and the detection region are positioned opposite to each other. In the detection device 1 according to Embodiment 1, therefore, the sensor just needs to be installed on only one side of the detection region, alignment of optical axes between the light projection unit 102 and the light receiving unit 103 is no longer required, and installation conditions are relatively moderate. Furthermore, in the detection device 1 according to Embodiment 1, a detection range is widened. Moreover, in the detection device 1 according to Embodiment 1, since the distance between the image sensor 1033 and the object 2 can be calculated, the position and the width of the object 2 can be calculated even with the use of a non-telecentric lens, and cost reduction can be realized in comparison with the related-art device.

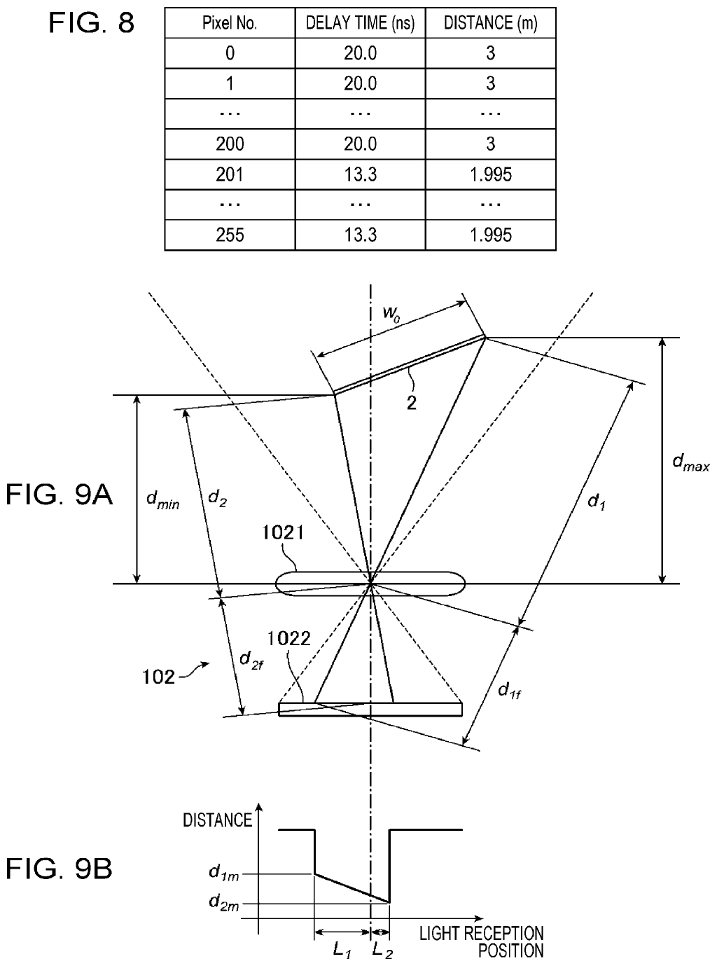

A specific example of the operation of the detection device 1 according to Embodiment 1 will be described below with reference to FIGS. 7 and 8. In the following description, as illustrated in FIG. 7, the detection device 1 is assumed to calculate the distance from the image sensor 1033 to the object 2 and an edge position of the object 2 (distance P₁ from the optical axis to an edge of the object 2). It is also assumed that a pixel pitch of the image sensor 1033 (distance between the light receiving elements) is 20 [μm], the number of pixels (number of the light receiving elements) is 256, and the focal length of the lens 1032 is 20 [mm]. In addition, the distance (d_{b} denoted in FIG. 7) from the image sensor 1033 to the background present in the detection region is 3 [m].

When the light projection unit 102 projects the pulsed light toward the background under the above-mentioned conditions, the light reception time (delay time) for each light receiving element is obtained with the image sensor 1033 and the distance to the reflection point for each light reception position is obtained with the distance calculation unit 104 as illustrated, by way of example, in FIG. 8. Then, the distance calculation unit 104 outputs, as the distance from the image sensor 1033 to the object 2, 1.995 [m] based on FIG. 8 in consideration of that the distance from the image sensor 1033 to the background is 3 [m].

Furthermore, the position calculation unit 105 calculates the edge position of the image of the object 2, focused on the image sensor 1033, on the basis of the results of calculations by the distance calculation unit 104. In the case of FIGS. 7 and 8, the pixel corresponding to the position of the optical axis is Pixel No. 128, and the pixel next to the pixel corresponding to the edge position of the object 2 is Pixel No. 200. Accordingly, on the basis of the distance from Pixel No. 128 to Pixel No. 200, the position calculation unit 105 outputs 0.00147 [m] as the edge position of the image of the object 2 (namely, the distance from the optical axis to the edge of the image of the object 2) .

Then, the MPU 106 calculates the edge position of the object 2 on the basis of the results of calculations by the distance calculation unit 104 and the position calculation unit 105. In the case of FIG. 8, the magnification of the optical system is 98.75. The MPU 106 multiplies the edge position of the image of the object 2 by the magnification of the optical system, and outputs 0.145 [m] as the edge position of the object 2 (namely, the distance P₁ from the optical axis to the edge of the object 2).

The above description has been made in connection with the case of using the linear-type image sensor 1033 including the plurality of light receiving elements arrayed in the one-dimensional direction. However, the present invention is not limited to that case, and the image sensor 1033 including a plurality of light receiving elements arrayed in two-dimensional directions may be used instead. In such a case, the detection device 1 can calculate not only the width of the object 2 present in the detection region, but also its height.

According to Embodiment 1, as described above, since the detection device 1 includes the light projection unit 102 that projects light to the detection region, the lens 1032 that focuses the light having been projected from the light projection unit 102 and reflected by the detection region, the image sensor 1033 that includes the plurality of light receiving elements and receives the light focused by the lens 1032 for each of the light receiving elements, the distance calculation unit 104 that calculates, on the basis of the result of the light reception by the image sensor 1033, the distance to the object 2 present in the detection region with the TOF method for each of light reception positions at which the light receiving elements are located, and the object position calculation unit that calculates the position of the object 2 on the basis of the distance calculated by the distance calculation unit 104 for each light reception position, the position of the object 2 can be detected using the reflection-type device.

Furthermore, since the detection device 1 includes the object width calculation unit that calculates the width of the object 2 on the basis of the distance calculated by the distance calculation unit 104 for each light reception position, the width of the object 2 can be detected.

### Embodiment 2

Embodiment 1 has been described in connection with the case in which the detection target surface of the object 2 is parallel to the light receiving surface of the image sensor 1033. On the other hand, Embodiment 2 represents a detection device capable of calculating the width of the object 2 even when the detection target surface of the object 2 is inclined with respect to the light receiving surface of the image sensor 1033.

An exemplary configuration of the detection device 1 according to Embodiment 2 is similar to that of the detection device 1 according to Embodiment 1 illustrated in FIG. 1.

The distance calculation unit 104 does not execute the conversion process of calculating the distance parallel to the optical axis with the use of the angle θ₁.

The MPU 106 calculates the width of the object 2 on the basis of a width from one end of the image of the object 2, focused on the image sensor 1033, to the position of the optical axis, a width from the other end of the above-mentioned image to the position of the optical axis, a distance from the one end of the image to a reflection point given by one end of the object 2, a distance from the other end of the image to a reflection point given by the other end of the object 2, a distance from the one end of the object 2 to the position of the optical axis on the lens 1032, and a distance from the other end of the object 2 to the position of the optical axis on the lens 1032.

In Embodiment 2, the MPU 106 calculates the width of the object 2 by using formulae (6) to (8) given below. In the formulae (6) to (8), w₀ denotes the width of the object 2. L₁ denotes the width from the one end of the image of the object 2 (corresponding to a first light reception position), focused on the image sensor 1033, to the position of the optical axis, and L₂ denotes the width from the other end of the above-mentioned image (corresponding to a second light reception position) to the position of the optical axis. Furthermore, d₁ₘ denotes the distance from the first light reception position to the reflection point given by the one end of the object 2 (first edge) and d₂ₘ denotes the distance from the second light reception position to the reflection point given by the other end of the object 2 (second edge). Moreover, d₁ denotes the distance between the first edge and the position of the optical axis on the lens 1032, and d₂ denotes the distance between the second edge and the position of the optical axis on the lens 1032. In addition, d_{1f} denotes the distance between position of the optical axis on the lens 1032 and the first light reception position, and d_{2f} denotes the distance between position of the optical axis on the lens 1032 and the second light reception position. Note that d_{1f} and d_{2f} are known. Thus the MPU 106 can calculate the width of the object 2 even when the object 2 is inclined with respect to the light receiving surface of the image sensor 1033.

$$\begin{matrix}{d}_{1} = {d}_{1 m} - {d}_{1 f} , {d}_{2} = {d}_{2 m} - {d}_{2 f} & ( 6 ) \\ {ϑ}_{1} = arcsin ( \frac{{d}_{1 f}}{{L}_{1}} ) , {ϑ}_{2} = arcsin ( \frac{{d}_{2 f}}{{L}_{2}} ) & ( 7 ) \\ {w}_{o} = \sqrt{{d}_{1}^{2} + {d}_{2}^{\underline{2}} - 2 {d}_{1} {d}_{2} cos ( {ϑ}_{1} + {ϑ}_{2} )} & ( 8 )\end{matrix}$$

The detection device 1 according to Embodiment 2 can be used as a collision avoidance sensor (range sensor) that is equipped in an AGV (Automated Guided Vehicle), for example. As that type of collision avoidance sensor, a laser scanning sensor including a movable mirror to reflect a laser beam has been used so far. By using the detection device 1 according to Embodiment 2 instead, since a movable component such as the above-mentioned mirror is no longer required, the sensor size can be reduced and a sensor with high resistance to vibration and shock can be realized. In such a case, the lens 1032 is desirably a wide-angle lens.

The invention of this application can be implemented in a variety of forms obtained by freely combining components of the individual embodiments, optionally modifying the components of the individual embodiments, or optionally omitting the components of the individual embodiments without departing from the scope of the invention.

### INDUSTRIAL APPLICABILITY

The detection device according to the present invention is suitable for being used as a detection device that is a reflection-type device and that is able to detect an object position, more specifically to detect the position of an object present in the detection region.

### REFERENCE SIGNS LIST

1 detection device

2 object

101 measurement control unit

102 light projection unit

103 light receiving unit

104 distance calculation unit

105 position calculation unit

106 MPU

107 input and output unit

108 communication unit

109 display unit

110 operating unit

111 measurement unit

112 sensor head

113 interface unit

1021 light projection board

1022 light emitting element

1023 aperture

1024 diffuser

1031 light receiving board

1032 lens

1033 image sensor

1121 filter

1. A detection device, comprising:
a light projector configured to project light to a detection region;
a lens that focuses the light having been projected from the light projector and reflected by the detection region;
an image sensor that includes a plurality of light receiving elements and receives the light focused by the lens for each of the light receiving elements;
a distance calculation circuit configured to calculate, on the basis of a result of light reception by the image sensor, a distance to an object present in the detection region with a TOF method for each of light reception positions at which the light receiving elements are located; and
an object position calculation circuit configured to calculate a position of the object on the basis of the distance calculated by the distance calculation circuit for each light reception position.

2. The detection device according to claim 1, wherein the object position calculation circuit is further configured to calculate the position to the object on the basis of a position of an image of the object, the image being focused on the image sensor, a distance from the image sensor to the object, and a focal length of the lens.

3. The detection device according to claim 1, further comprising an object width calculation circuit configured to calculate a width of the object on the basis of the distance calculated by the distance calculation circuit for each light reception position.

4. The detection device according to claim 3, wherein the object width calculation circuit calculates the width of the object on the basis of a width of an image of the object, the image being focused on the image sensor, a distance from the image sensor to the object, and a focal length of the lens.

5. The detection device according to claim 3, wherein the object width calculation circuit is further configured to calculate the width of the object on the basis of a width from one end of an image of the object, the image being focused on the image sensor, to a position of an optical axis, a width from the other end of the image to the position of the optical axis, a distance from the one end of the image to a reflection point given by one end of the object, a distance from the other end of the image to a reflection point given by the other end of the object, a distance from the one end of the object to a position of the optical axis on the lens, and a distance from the other end of the object to the position of the optical axis on the lens.

6. The detection device according to claim 1, wherein the light receiving elements are arrayed in a one-dimensional direction.

7. The detection device according to claim 1, wherein the lens is a non-telecentric lens.
